(19) United States
(12) Patent Application Publication
(10) Pub. No.: US 2008/0034436 A1
(43) Pub. Date: Feb. 7, 2008

(54) Distribution of Content

(75) Inventors: Timo Elomaa, Tampere (FI); Vesa Palomaki, Espoo (FI)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 11/839,230

(22) Filed: Aug. 15, 2007

Related U.S. Application Data
(62) Division of application No. 10/023,735, filed on Dec. 21, 2001.

(30) Foreign Application Priority Data
Dec. 21, 2000 (GB) 0031370.0

(51) Int. Cl. H04L 9/00

(52) U.S. Cl. 726/26

(57) ABSTRACT

A content distribution system is described in which indicia defining a level of copyright control are encapsulated together with content to which it relates in a datagram for a delivery over a network. Depending on the level of copyright control defined by the indicia, a terminal receiving the content is restricted in the operations it can carry out on the content including saving, reading and forwarding the content.

### BACKGROUND OF INVENTION

The present invention relates to the distribution of content over networks, particularly although not exclusively content having digital rights such as copyright therein.

A particular challenge to the content generating community which includes record companies, publishers and other right holders, is the ease with which digital content may be disseminated particularly over networks. This ease of dissemination is also coupled with the fact that there is little or no degradation in the quality of the content despite repeat copying and forwarding of the content in its original format. Thus, unauthorised copies of copyright context will meet the same high expectations of consumers in relation to the authorised content.

Consequently, right holders have been reluctant to make their content available for distribution over networks. In a parallel development, efforts are presently being made to prevent or at least restrict the ability of purchasers of such content to make further copies thereof.

Where content has been made available for distribution over networks, various proposals have been made to counter the loss in revenue to right holders. Broadly, these have constituted, on the one hand, the creation of technical barriers to unauthorised copying of content and on the other hand, the development of transactional controls. In many cases both approaches have been used in tandem to attempt to strictly control the distribution of content to authorised recipients namely those users who have paid the appropriate fee to the right holder. The implementation of such techniques does require significant processing power and requires specific hardware and/or software features in a terminal. Indeed, as the sophistication of those seeking unauthorised access to content increases, the demands for processing power will only increase. Furthermore, as many proprietary approaches exist there result in a multiplicity of hardware and software features in different terminals. As a result of the ensuing poor level of interoperability and concomitant fragmentation of the market, right holders are reluctant to invest in making content available.

### SUMMARY OF THE INVENTION

Thus, according to one aspect of the present invention, there is provided a content distribution control system comprises a network having at least one terminal connected thereto, a content creation tool operable to assign indicia representative of a pre-determined level of control of said content, said content being subsequently made available to said network and said at least one terminal being responsive to said indicia to permit operations in relation to said content received from said network.

The content creation tool may be an application resident on a terminal thereby allowing users to generate their own content such as ringtones and to assign a desired level of protection to that content. At the other end of the scale, a publisher might utilise such a tool to make their works available over a network in which case a level of control for such content may be assigned. The content need not be provided in an electronic format but could be distributed on Compact Disc (CD) or Digital Versatile Disc (DVD), the only requirement being that the indicia remain with the content when it is transferred to other media including uploading the content to a network. Thus, the right holder is assured that his intentions regarding dealings with the content are preserved. To deter unauthorised dealings in the content, the indicia may be encrypted and/or encryption may be utilised over those channels of communication via which the content is distributed. The simplicity of the approach facilitates its implementation on all platforms including relatively thin clients such as mobile terminals unsuitable for implementing the computationally and resource intensive demands of prior art content distribution systems. Thus there is no need to implement blanket prohibition of the forwarding of right holder's content from terminals such as hitherto been the case with ringtones for example.

According to another aspect of the present invention, there is provided a terminal having a first memory into which content is receivable, a second memory and a user interface operatively associated with said memories, such that a set of operations of said user interface in relation to said content received into said first memory is permitted by reference to said content, at least one of said operations permitted by said content being a transfer of said content to said second memory, wherein a set of operations of said user interface in relation to said same content when received into said second memory is similarly permitted by reference to said content.

It will be recognised that because the user interface is responsible for managing the operations permitted or allowed in respect of the content and that the content itself is otherwise unavailable to a typical user, there is no requirement for computationally and resource intensive cryptographic protection of the content. Preferably, the first memory is volatile with the result that content is not retained in the terminal unless the indicia permits transfer of the content to the second non-volatile memory. However, the terminal may implement session level cryptography to protect the content during transit over the network.

According to a further aspect of the present invention, there is provided a method of creating content for controlled distribution comprises defining indicia representative of respective levels of control of content, determining a level of control appropriate to said content and assigning indicia to said content in accordance with said determination.

Because the level of control may be set during the creation of content a right holder is able to set out at the outset his intention regarding the copyright status, for example, of that content. Attempts to defeat this intention by removing such indicia may be actionable and thus the presence of the indicia acts as a form of legal tripwire which can be tested in cases of unauthorised use of the content. Furthermore, the indicia, by remaining intact during transfer of the content, ensures that the intentions of the right holder are retained even where the content is transferred between different media including physical devices such as Compact Discs and Digital Versatile Discs and electronic copies held on web servers, for example. The management of such rights is further enhanced as a user interface of a terminal or other device receiving such a content can be programmed to respond in a predetermined manner to content having particular indicia. Such a simplification of the management process reduces the computational and other resource requirements of a terminal.

According to a still further aspect of the present invention, there is provided a method of receiving content including indicia representative of allowable operations in respect of said content, which comprises receiving said content into a first memory, generating a list of allowable operations in relation to said content from said indicia and displaying said list to a user.

One at least of the allowable operations will be transferring the content to a second, non-volatile, memory. However, in some circumstances, for example, where the content is intended for promotional purposes, such a transfer will be prohibited by the indicia. In which case, the content would be deleted when the first volatile memory is purged or the terminal powered down. Consequently, the opportunity to seek to hack or otherwise carry out unauthorised activity in relation to the content will be denied.

### BRIEF DESCRIPTION OF THE DRAWINGS

In order to understand the present invention more fully, a number of embodiments thereof will now be described by way of example and with reference to the accompanying drawings, in which:

FIG. 1 is a schematic view of a communication network in accordance with one aspect of the present invention;

FIG. 2 is a diagrammatic view of a terminal for use with the network of FIG. 1 in accordance with a further aspect of the invention;

FIG. 3 is a diagrammatic view of a datagram for use with the network of FIG. 1 in accordance with a further aspect of the invention;

FIG. 4 is view of information shown on a display of the terminal of FIG. 2; and

FIGS. 5a, 5b and 5c are all views of different information shown on a display of the terminal of FIG. 2.

### DETAILED DESCRIPTION OF THE INVENTION

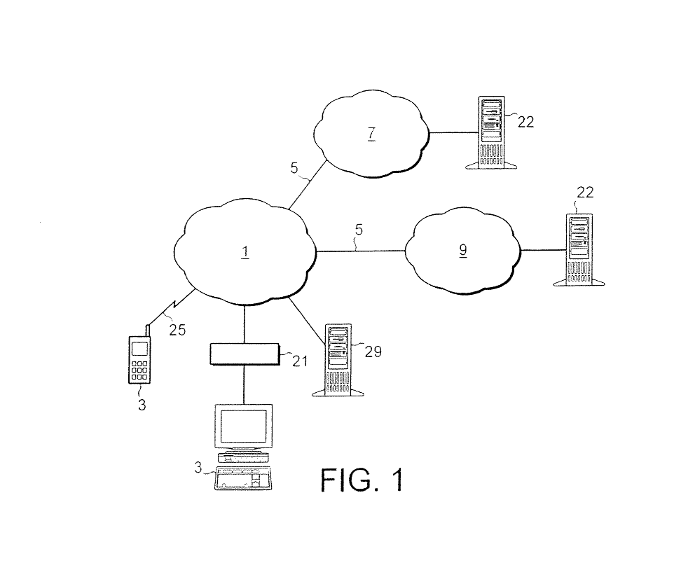

Referring to FIG. 1, there is shown a communication network 1 to which a plurality of terminals 3 has access. The network 1 has interworking connections 5 to external networks 7 including the Internet 9. In addition to locally created content and through these external connections 5 allow content to enter the communication network 1.

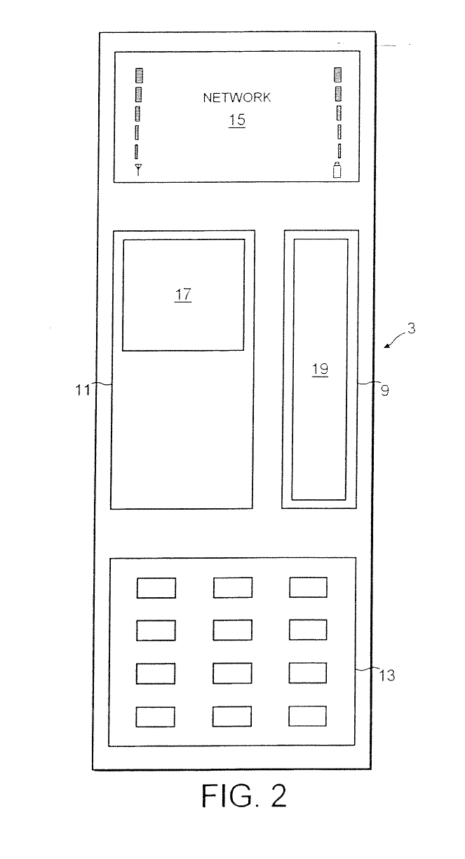

Referring in particular to FIG. 2, a terminal 3 for use with the network 1 is provided with a processor 9, memory 11 and data input 13 and output devices 15. The memory 11 includes a cache 17 into which data is received from the network 1. The cache 17 operates by retaining data on a temporary basis which is being used by the terminal 3 thereby preventing repeat requests from the terminal 3 for the network 1 to deliver the same data. At the end of a communication session and/or when data has not been accessed for a predetermined time period, the cache 17 is emptied. The terminal 3 is provided with a User Interface (UI) 19 to namely an application which controls reprocessing co-ordinate the activities of the terminal 3 in response to inputs from a user and/or the network 1.

The terminal 3 may be connected to the network 1 in a conventional manner. Thus a fixed terminal may be connected by a modem 21 connected to the network, for example. In the case of a mobile terminal, the connection may be over an air interface 25, in which case the terminal 3 will include the appropriate well known additional elements required to perform this function. The techniques for connection of such terminals to the network 1 will be readily apparent to those skilled in the art.

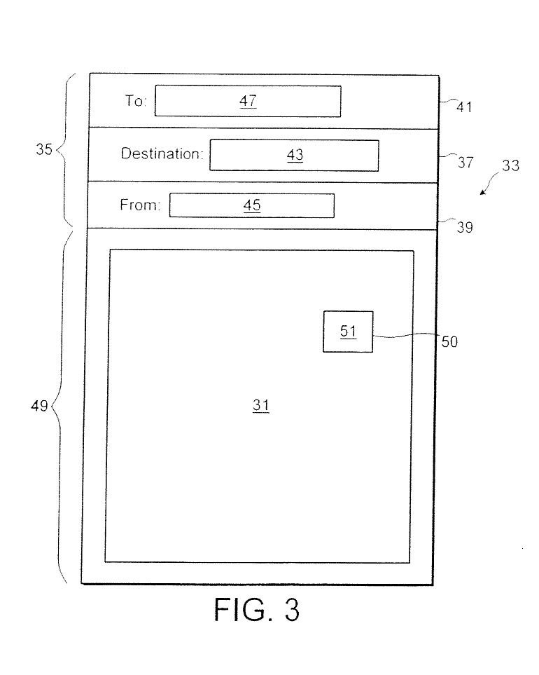

As has already been mentioned, content may enter the network 1 from externally connected content providers 22 or the network 1 itself may incorporate content providers 29 including, but not limited to, the terminals 3 themselves. As shown in FIG. 3, content 31 is encapsulated in a datagram 33 formatted in accordance with the frame type of the protocol the network 1 is operating. Typically, the datagram 33 has a header portion 35 which is provided with fields 37, 39, 41 containing a destination address 43 and respectively the address 45 of the sender's device and an initial router address 47 determined from a look-up table or similar held by the terminal 3. In the case of a so-called second generation Public Land Mobile Network (PLMN) as exemplified by GSM, the content 31 may be in the form of text or ringtone data carried by a Short Message (SM). In which case the destination address 43 will be the receiving terminal's telephone number, the sender's address 45 the sending terminal's telephone number and the initial router address 47 the Short Message Service Centre telephone number. The content 31 itself is conveyed in a payload portion 49 of the datagram 33.

The content 31 contains a value indicative of a control or copyright class 51 to which belongs. This may take the form of a value placed in a sub division 50 of the payload portion 49 or elsewhere within the content 31. The class 51 is initially assigned to a contents 31 by an application under the control of the right holder or a party authorised by him within the function of a service creation tool (not shown). Such tools are commonly used to create personalisation material such as ringing tones, profile icons, picture messages, screen savers and digital images, to name but some possibilities. The digital rights associated with such material will vary and thus a suite of options is available within the tool to set an appropriate level of protection. Each level of protection will place a different level of restriction on the use a recipient may make of the content 31. The indication of the class 51 may be performed by setting a bit to a corresponding state. Depending on the resources available, the indication of class 51 may be used to deliver more detailed information relating to the content 31 with which it is associated.

One of the functions of the terminal UI 19 is to control the delivery of datagrams for a user as exemplified by the delivery of an SM to a mobile terminal 3 connected to a GSM network 1, for example. When a datagram 33 is received by the terminal 3, it is placed in the cache 17 which is accessible to the UI but not otherwise accessible to a user operating the terminal 3 in a normal fashion. A UI function examines the payload portion 49 for a value indicative of the control class 51 applied to the content encapsulated by the datagram 33. As previously mentioned, the value may be placed in a sub-division 50 within the payload portion 49 or indeed any other predetermined location within the datagram 33.

The value 51 is then compared by the UI function against a set of pre-existing conditions each representing a set of allowable and prohibited operations in relation to the content 31. These correspond, of course, to those assignable by the content creation tool. If necessary, these conditions could be varied by a network operator in concert with a right holder, by delivering a new set of conditions to the terminal 3 to reflect changes in a content creation tool.

By way of example, three conditions and corresponding control value or other indicia may be established in relation to user operations that may be carried out in relation to content 31. Firstly, that the content 31 may be viewed only; secondly, that the content 31 may be viewed and saved locally within the terminal 3; and thirdly, that the content may be viewed, saved locally within the terminal 3 and freely forwardable over the network 1 such as, for example, to other terminals 3.

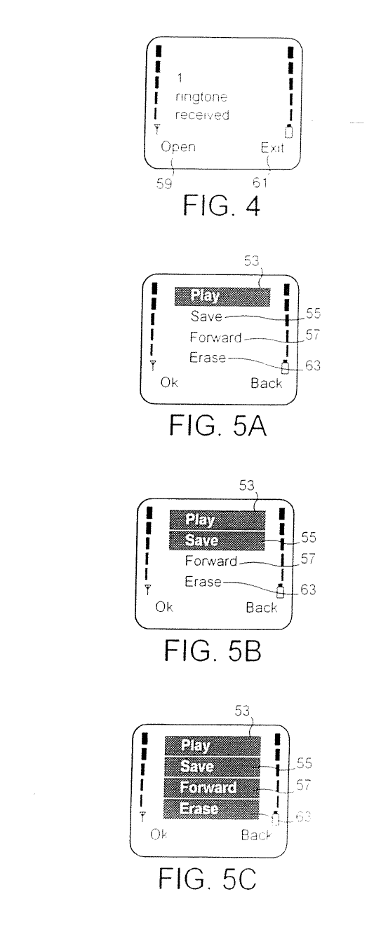

In use, a datagram 33 such as a SM will be received by the terminal 3 to which it is directed and the datagram 33 stored temporarily in the cache 17. The UI function 19 will subsequently display to the user a message (FIG. 4) indicating that a SM, such as a ringtone, has been received. The user will be given the option at this stage to either open 59 the SM or to discard it by exiting 61 the UI function. In this latter case 61, the UI function will issue an instruction to clear the cache 17.

Presuming the user elects to open 59 the SM one of the three displays illustrated in FIGS. 5a, 5b and 5c will be displayed by the UI function 19 in accordance with the indicia 51 set by the content creation tool. The nature of the display will depend on the indicia 51 associated with the content 31. Thus, the operations allowed to a user might include, in the case of a ringtone, the playing the ringtone, saving the ringtone for future local use, forwarding the ringtone to another terminal and lastly erasing the ringtone. For different forms of content 31, it will be appreciated that alterations may be made to the operations available to the user although the operation to save and forward will always be present although perhaps prohibited under certain classes of control.

FIG. 5a represents a terminal 3 display 15 to a user in which the first class of copyright control has been placed upon the content 31. Thus, the options to save 55, forward 57 or erase 63 the SM have be greyed out leaving the only option open to the user of playing 53 the ringtone. Such a copyright class would allow a user to access content for promotional or investigatory purposes only. Under this classification, there is no option to retain the SM for later local use or to forward it. Thus, once the UI function 19 has been exited through the requisite menu selections or indeed the terminal has been powered down, the cache 17 is cleared and the SM is no longer available. Clearly, there is no need to enable the option to erase the content 31 as this will occur in any case on exiting the UI function or switching off the terminal.

FIG. 5b represents a terminal 3 display 19 in which a second class of copyright control has been placed upon the content 31. Thus, the option to forward 57 the content to another terminal has been greyed out leaving the options of playing 53 or saving 55 the content 31 locally are available to the user. Such a control class would allow a user access to content 31 he has purchased without melody the right to disseminate it further.

Finally, FIG. 5c represents a terminal 3 display 19 in which a third class of copyright control has been placed upon the content 31. Thus, the options to forward 57, save 55 and play 53 together with the option to erase 63 the content 31 are available to the user. Such a class would be the default setting for content 31 not attributable to any right holder.

Depending on the class and options allowed to a user, selection from a menu will result in the UI carrying out the relevant action, which in the case of saving 55 the SM will result in the content 31 being transferred from the cache 17 into the memory non-volatile 11 of the terminal 3. The remaining options result in the UI operating directly on the content held in the cache 17.

It will be appreciated that by placing the copyright control information in a portion 36 of the datagram 33 which remains in the cache 17, at least until it is saved to the terminal menus 11, provides basic protection against hacking. Furthermore, once the content 31 has been stored locally, separate security measures may be employed to guard against hacking the copyright control class 51 of the stored content.

Nevertheless, to protect against more sophisticated hacking, the header portion may further include a checksum value of the entire content held in the payload portion 36. The UI function could initially determine whether the checksum was correct and if not this would be indicative of either data corruption during the transmission process or an attempt to make an unauthorised change to the copyright control class 51. For example, a checksum could consist of a simple sum of the sub division 34 and content 31 the payload 34 divided by a pre-selected prime number. The remainder would then serve as an indicator of the integrity of the copyright control class 51.

Further security measures such as those necessary to avoid so-called man in the middle attacks or modification of the terminal itself could be defeated by utilising the Public Key Infrastructure (PKI) and a suitable cryptographic technique. Thus, a PKI based technique would be utilised to establish a secure connection between a pair of terminals 3 or a terminal 3 and a content provider between which a datagram 33 containing copyright content would travel.

What is claimed:

1. A method of controlling distribution of content, comprising the steps of:
determining a level of distribution of content to be distributed, said level representing permitted uses of said content; and
controlling distribution of said content by setting an indicia, corresponding to said content, to a state indicative of said level determined by said determining step.

2. A method as claimed in claim 1, wherein said content to be distributed and said indicia are included in a datagram.

3. A method as claimed in claim 2, wherein said indicia is a bit included in said datagram that has been set to a predetermined state corresponding to said level.
